(19) United States
(12) Patent Application Publication
(10) Pub. No.: US 2024/0212228 A1
(43) Pub. Date: Jun. 27, 2024

(54) IMAGE GENERATING AND RETRIEVING APPARATUS, IMAGE GENERATING AND RETRIEVING SYSTEM, AND IMAGE GENERATING AND RETRIEVING METHOD

(71) Applicant: Hitachi, Ltd., Tokyo (JP)

(72) Inventors: Yuki WATANABE, Tokyo (JP); Ryosuke MIKI, Tokyo (JP); Atsushi HIROIKE, Tokyo (JP); Soichiro OKAZAKI, Tokyo (JP); Koichiro ITO, Tokyo (JP); Hiroto NAGAYOSHI, Tokyo (JP)

(73) Assignee: Hitachi, Ltd., Tokyo (JP)

(21) Appl. No.: 18/503,440

(22) Filed: Nov. 7, 2023

(30) Foreign Application Priority Data
Dec. 26, 2022 (JP) 2022-208861

(51) Int. Cl. G06T 11/00; G06F 16/532; G06F 16/583; G06V 10/44

(52) U.S. Cl. CPC G06T 11/00; G06F 16/532; G06F 16/583; G06V 10/44; G06V 2201/07

(57) ABSTRACT

Provided is an image generating and retrieving apparatus that enables a user to easily find a desired image from a large number of image generation results. A similarity is calculated from a text feature amount and an image feature amount, a similar image similar to a retrieval target is retrieved from an image text database using the similarity, and an image generation process held in the image text database is visualized.

### BACKGROUND OF THE INVENTION

### 1. Field of the Invention

The present invention relates to an image generating and retrieving apparatus, an image generating and retrieving system, and an image generating and retrieving method.

### 2. Description of the Related Art

By utilizing an artificial intelligence (AI) technology, not only an image captured in an image can be recognized with high accuracy (see GLIPv2: Unifying Localization and VL Understanding), but also a method of generating an image itself is rapidly developed.

The Generative Adversarial Networks (GAN) proposed in 2014 is a model that includes two neural nets, a discriminator and a generator, and generates an image close to a real thing from the generator by learning a training image so that the two compete with each other.

In early 2021, research on a method for controlling the output of an image generation model by utilizing a large-scale language model has progressed (see Learning Transferable Visual Models From Natural Language Supervision), and in 2022, high-quality image generation using a diffusion model, which is a method different from GAN, has become possible (see High-Resolution Image Synthesis with Latent Diffusion Models).

A recent image generation model can generate an image of a complicated concept along the content of an explanatory text input in a natural language. Image generation by AI can be utilized not only for content creation but also for collection of training data of AI itself. In particular, since it is difficult to collect videos of rare cases such as disasters and accidents, if a generation model can be appropriately controlled to generate a large number of images suitable for use cases, development of an image recognition system can be accelerated.

For example, an image generation device of JP 2019-153223 A (JP 6865705 B2) includes: an acquisition unit that acquires information regarding an ingredient input by a user and random number data randomly generated; and a learned generation unit that generates a dish image using a learned model for generating the dish image by using the information regarding the ingredient and the random number data acquired by the acquisition unit as inputs, thereby simply providing a dish image with room for ingenuity to assist rich variations of dishes.

Furthermore, the information processing apparatus of JP 2020-102041 A causes a computer to execute the steps of: displaying a plurality of pieces of first image data; receiving selection of a plurality of pieces of second image data among the plurality of pieces of first image data in accordance with an operation of a user; generating a plurality of pieces of third image data having a feature corresponding to a combination of features of the plurality of pieces of second image data; and switching and displaying the plurality of pieces of third image data in units of a predetermined number of pieces in accordance with an operation of the user, thereby easily generating image data according to a desire of the user.

### SUMMARY OF THE INVENTION

In the image generation device of JP 2019-153223 A (JP 6865705 B2), the user inputs the ingredient name in a natural language, so that the content of the image output by the image generation model can be controlled. However, since the output image changes due to the randomly generated random number, it takes time to confirm the result. In addition, in a case where an image as expected is not generated, it is necessary to repeat the processing many times or to perform trial and error by changing the combination of ingredient names.

The information processing apparatus of JP 2020-102041 A acquires a generated vector that is a source of a generated image by the user selecting the generated image, and generates an image tended by the user by generating a new image using the generated vector. However, since it is necessary for the user to determine the generated image, it takes time to determine when a large number of images are generated. In addition, since a feedback to generation processing is in a vector format that is illegible for the user, the feedback cannot be applied to image generation using a natural language as an input.

An object of the present invention is to provide an image generating and retrieving apparatus capable of easily finding a desired image by a user from a large number of image generation results.

An image generating and retrieving apparatus according to one aspect of the present invention is an image generating and retrieving apparatus having a processor, the image generating and retrieving apparatus including: an image generation unit that acquires, by the processor, a new generated image by image generation processing from an input text and an input image that have been input; a text registration unit that calculates a text feature amount from the input text by the processor; an image registration unit that calculates an image feature amount from the input image and the generated image by the processor; an image text database that holds the input text, the input image, the generated image, the image feature amount, the text feature amount, and an input/output relationship in the image generation processing as an image generation process; a retrieval unit that calculates a similarity from the text feature amount and the image feature amount by the processor, and retrieves a similar image similar to a retrieval target from the image text database by using the similarity; and a display unit that visualizes the image generation process held in the image text database by the processor.

According to one aspect of the present invention, it is possible to provide an image generating and retrieving apparatus capable of easily finding a desired image by a user from a large number of image generation results.

### BRIEF DESCRIPTION OF THE DRAWINGS

FIG. 1 is a block diagram illustrating a configuration of an image generating and retrieving system;

FIG. 2 is a block diagram illustrating a hardware configuration of the image generating and retrieving system;

FIG. 3 is a diagram illustrating a structure of an image/text database;

FIG. 4A is a diagram illustrating image generation processing;

FIG. 4B is a diagram illustrating image generation processing;

FIG. 4C is a diagram illustrating image generation processing;

FIG. 5 is a flowchart illustrating image generation and database construction processing;

FIG. 6A is a diagram illustrating image retrieval processing;

FIG. 6B is a diagram illustrating image retrieval processing;

FIG. 7 is a flowchart illustrating image retrieval processing;

FIG. 8 is a diagram illustrating visualization of an image generation process;

FIG. 9 is a flowchart illustrating visualization processing of the image generation process;

FIG. 10 is a diagram illustrating filtering of an image generation result by similar image retrieval;

FIG. 11 is a flowchart illustrating filtering processing of an image generation result by similar image retrieval;

FIG. 12 is a diagram illustrating filtering of an image generation result by image recognition;

FIG. 13 is a flowchart illustrating filtering processing of an image generation result by image recognition;

FIG. 14 is a diagram illustrating text input assistance by similar image retrieval;

FIG. 15 is a flowchart illustrating text input assisting processing by similar image retrieval;

FIG. 16 is a diagram for explaining mask image input assistance by similar image retrieval;

FIG. 17 is a flowchart illustrating mask image input assist processing by similar image retrieval;

FIG. 18 is a diagram illustrating a screen example of the image generating and retrieving system; and

FIG. 19 is a sequence diagram illustrating processing of the entire image generating and retrieving system.

### DESCRIPTION OF THE PREFERRED EMBODIMENTS

Hereinafter, embodiments of the present invention will be described with reference to the accompanying drawings. The present embodiment is merely an example for realizing the present invention, and does not limit the technical scope of the present invention. In the drawings, common configurations are denoted by the same reference numerals.

### Example 1

An image generating and retrieving apparatus 104 according to the present Example 1 automatically generates an image according to the content of the text on the basis of the input text or image. In addition, the feature amount is extracted from the input or generated text/image, and an image/text database 110 for retrieving a similar image is constructed together with the input/output relationship information of the image generation. By using the database retrieval function, the user can confirm a past image generation process and efficiently find a desired image from a large number of generated images.

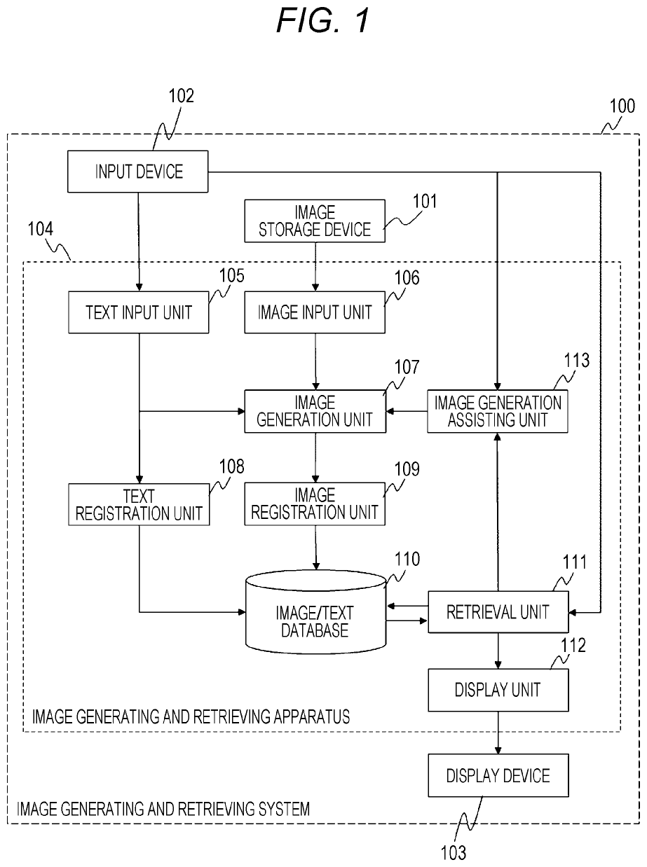

FIG. 1 is a block diagram illustrating a configuration example of an image generating and retrieving system 100 according to Example 1.

As a use case of the image generating and retrieving system 100, content creation, data collection for machine learning, and the like can be considered, but the use case is not limited thereto. Each configuration will be described below.

The image generating and retrieving system 100 automatically generates an image according to the content of the text from the text or the image input by the user, and registers the image in the image/text database 110. The image generating and retrieving system 100 includes an image storage device 101, an input device 102, a display device 103, and an image generating and retrieving apparatus 104. The image storage device 101 is a storage medium that stores still image/moving image data or bibliographic information accompanying the still image/moving image data, and is configured using a computer built-in hard disk drive or a storage system connected by a network such as a network attached storage (NAS) or a storage area network (SAN). Furthermore, the image storage device 101 may be a cache memory that temporarily holds data continuously input from a photographing device.

The input device 102 is an input interface, such as a mouse, a keyboard, or a touch device, for conveying a user's operation to the image generating and retrieving apparatus 104. Furthermore, a voice input interface capable of inputting a text by voice recognition may be used. The display device 103 is an output interface such as a liquid crystal display, and is used for displaying a retrieval result of the image generating and retrieving apparatus 104, an interactive operation with a user, and the like.

The image generating and retrieving apparatus 104 is an apparatus that performs image generation processing of generating an image according to the content of a text from a text or an image input by a user, registration processing for creating a database of the input/generated image/text, and retrieval/display processing for processing a generation result and presenting the generation result to the user.

The image generating and retrieving apparatus 104 includes a text input unit 105, an image input unit 106, an image generation unit 107, a text registration unit 108, an image registration unit 109, an image/text database 110, a retrieval unit 111, a display unit 112, and an image generation assisting unit 113.

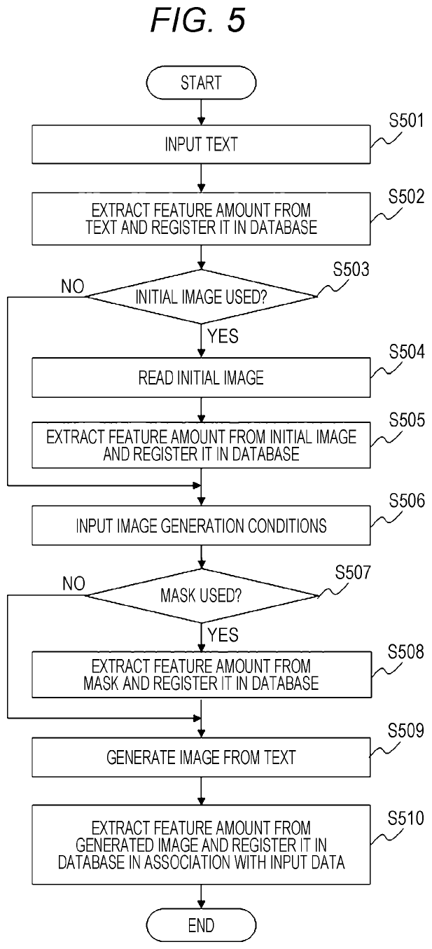

Image generation and database registration processing will be described below. Note that details of the processing will also be described with reference to the flowchart of FIG. 5.

In the image generation processing, an image according to the content of the text is automatically generated from the text input from the input device 102 by the user. Furthermore, the existing image recorded in the image storage device 101 can be used as an input and can be corrected in accordance with the content of the text. In the database registration processing, feature amounts for similar image retrieval are extracted from the input text/image and the generated image, and registered in the image/text database 110.

The feature amount is numerical data in a multi-dimensional vector format, and similarity of data of a feature amount extraction source can be determined by calculating cosine similarity between two vectors. By using a model learned by a pair of an image and a text for feature amount extraction, similarity between the image and the image, between the image and the text, and between the text and the text can be calculated by a similar procedure. In the database registration processing, the input/output relationship of the image generation processing is registered in the image/text database 110. This makes it possible to present a process of past image generation processing.

The text input unit 105 receives a text input by the user using the input device 102 and converts the received text into a data format to be used inside the image generating and retrieving apparatus 104. Basically, the image generation technique targeted in the present invention can use a text in a natural language as an input, but there are many restrictions on the type of language and the length of the text.

In addition, a predetermined set of terms may be received instead of natural language. Furthermore, the term may be emphasized or weakened according to a specific description rule. Therefore, the text input unit 105 converts the input text according to the image generation model used by the image generation unit 107. For example, a Japanese text is translated into an English text. In a case where a plurality of machine learning models are used in the image generation unit 107, a plurality of converted texts converted in accordance with the respective constraints are output.

The image input unit 106 receives an input of still image data or moving image data from the image storage device 101, and converts the data into a data format used inside the image generating and retrieving apparatus 104. For example, when the data received by the image input unit 106 is moving image data, the image input unit 106 performs moving image decoding processing of decomposing the data into frames (still image data format). In addition, in the case of stroke information input using a mouse or a touch device, the information is drawn in an image.

The image generation unit 107 automatically generates an image according to the content from one or more texts using the image generation model. The image generation model uses model parameters obtained by training a large number of images and their explanatory texts by deep learning using an image generation algorithm as in High-Resolution Image Synthesis with Latent Diffusion Models. Therefore, the generated image greatly changes depending on not only the input text but also the image generation algorithm and the learning data. In addition, in an algorithm in which an initial value is given by random noise, a generated image changes also by a random number seed.

Depending on the image generation algorithm, an image can be input to change the image according to the text, or a mask image for changing only a part of the image can be input. Furthermore, two or more texts can be input to generate an image of an intermediate concept thereof, or an image including no element of the text can be generated by inputting a negative text. In this manner, the image generation unit 107 can generate images of various variations according to the input. In addition, by using a plurality of image generation models, it is possible to generate a large number of different images at a time from conditions input by the user.

The text registration unit 108 extracts a feature amount from the input text acquired by the text input unit 105 and used for image generation. The feature amount is usually given by fixed-length vector data, and similarity between the two pieces of original data can be obtained by calculating a Euclidean distance between the two vectors, cosine similarity, or the like. In addition, by using the language/image feature amount extraction model described in Learning Transferable Visual Models From Natural Language Supervision, it is possible to obtain a feature amount with which similarity can be compared from a text and an image.

The image registration unit 109 extracts a feature amount from the input image acquired by the image input unit 106 or the generated image generated by the image generation unit 107. The image registration unit 109 of the present invention extracts a feature amount from an image using a feature amount extraction model similar to that of the text registration unit 108.

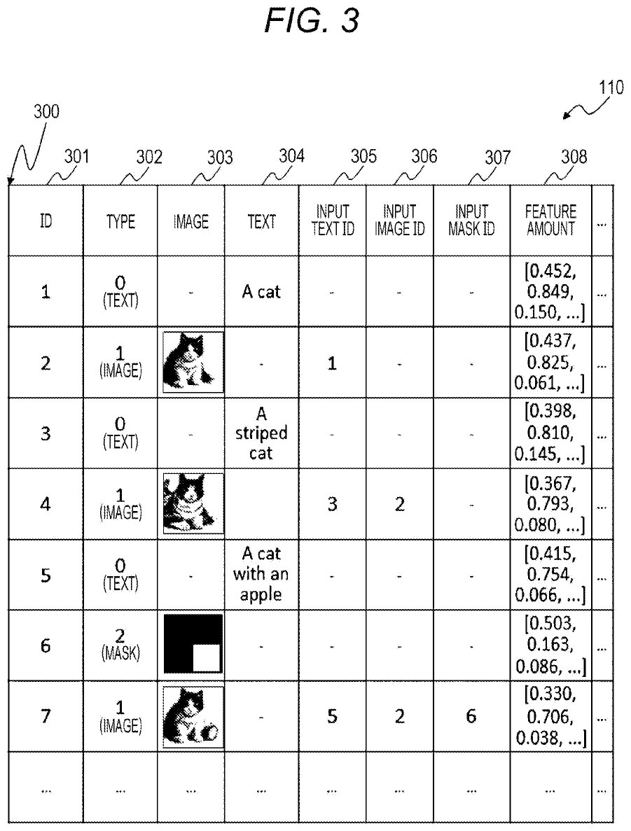

The image/text database 110 holds input texts/images or generated images, feature amounts thereof, and information on an input/output relationship of image generation processing. The image/text database 110 can retrieve registration data satisfying a given condition and read data with a specified ID for inquiries from each unit of the image generating and retrieving apparatus 104. In addition, it is possible to output the registration data similar to the query by using the feature amount extracted from the image or the text. Details of the structure of the image/text database 110 will be described later with reference to FIG. 3.

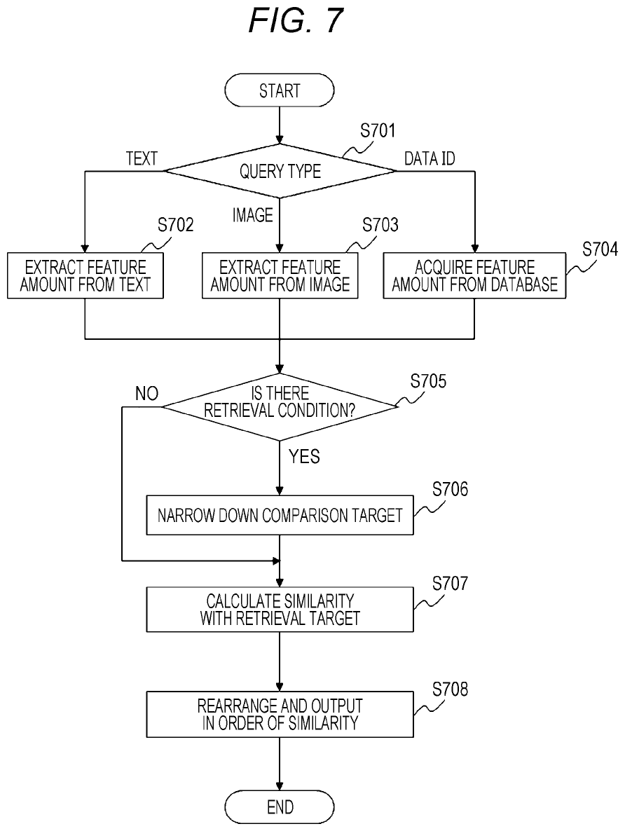

The above is the operation of each unit in the image generation and database registration processing of the image generating and retrieving apparatus 104. Next, the operation of each unit in the retrieval/display processing of the image generating and retrieving apparatus 104 will be described. Note that details of the processing will also be described with reference to the flowchart of FIG. 7.

In the retrieval/display processing, an image matching the retrieval condition is retrieved from the image/text database using the retrieval condition specified by the user from the input device 102, and information is presented on the display device 103. For example, the database can be retrieved with a retrieval query given by a text or an image, and the images registered in the database can be rearranged and displayed in order of similarity.

The text used for image generation may be used as a retrieval query, or an image as a result of image generation may be used as a query. As a result, the user can obtain a desired image not only from the image generated in the last image generation procedure but also from images generated in the past. In the retrieval/display processing, the input/output relationship of image generation registered in the image/text database 110 can be visualized. As a result, the user can generate a new image with reference to the past generation process.

The retrieval unit 111 acquires the image/text data from the image/text database 110 using the specified retrieval condition. In a case where the query is given by a conditional expression, the registration data matching the condition is returned. In a case where the query is given by vector data, similarity calculation between vectors is performed, and data rearranged according to the similarity is returned. Furthermore, in order to obtain information necessary for the user, the retrieval unit 111 can also process data by necessary analysis processing on the image and text acquired from the image/text database 110.

The display unit 112 displays the data acquired from the image/text database 110 on the display device 103. For example, the generated image and the similar image thereof may be displayed side by side, or a graph indicating an input/output relationship in the image generation process may be displayed.

The image generation assisting unit 113 assists input of image generation by the user using the result of the retrieval unit 111. For example, from the similar image acquired by the retrieval unit 111, one image specified by the user can be used as an initial image for generating a new image, or a text used in the past can be used again as an input text. Furthermore, for example, in a case where a plurality of image generation models are used, a new image may be generated by activating only the image generation model that outputs a large number of results determined to be desirable by the user.

The above is the operation of each unit in the retrieval/display processing of the image generating and retrieving apparatus 104. Note that the image generation/registration processing and the retrieval/display processing of the image generating and retrieving apparatus 104 are processing repeatedly performed according to an instruction of the user, the content of the image/text database 110 is sequentially added and updated, and the processing content of each unit using the registration data changes accordingly. In addition, if the exclusive control of the database update is appropriately performed, a plurality of users can simultaneously access and use the database.

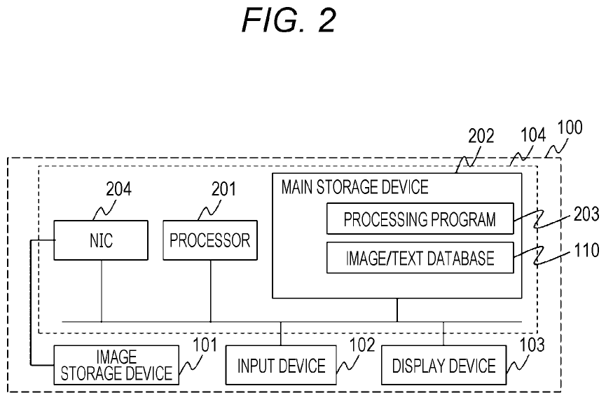

FIG. 2 is a block diagram illustrating a hardware configuration example of the image generating and retrieving system 100 of the present Example. The image generating and retrieving apparatus 104 includes a processor 201 and a storage device 202 connected to each other. The storage device 202 includes any type of storage medium. The storage device 202 includes a combination of storage devices such as a semiconductor memory and a hard disk drive.

Note that the functional units such as the text input unit 105, the image input unit 106, the image generation unit 107, and the text registration unit 108 illustrated in FIG. 1 are implemented by the processor 201 executing a processing program 203 stored in the storage device 202. In other words, the processing executed by each functional unit is executed by the processor 201 on the basis of the processing program 203.

The data of the image/text database 110 is stored in the storage device 202. Note that, in a case where the image generating and retrieving system 100 includes a plurality of devices for the purpose of processing load distribution or the like, the device including the image/text database 110 and the device that executes the processing program 203 may be physically different devices connected via a network, or the processing program 203 may be simultaneously executed by a plurality of devices as long as consistency of data recorded in the image/text database 110 can be held.

The image generating and retrieving apparatus 104 further includes a network interface device (NIC) 204 connected to the processor 201. The image storage device 101 is assumed to be NAS or SAN connected to the image generating and retrieving apparatus 104 via the network interface device 204. Note that the image storage device 101 may be included in the storage device 202.

FIG. 3 is an explanatory diagram illustrating a configuration and a data example of the image/text database 110 of the present Example. In the present embodiment, the information used by the system may be expressed by any data structure without depending on the data structure. Although FIG. 3 illustrates an example of a table format, for example, a data structure appropriately selected from a table, a list, a database, or a queue can store information.

The image/text database 110 includes, for example, an image/text information table 300. The table configuration and the field configuration of each table in FIG. 3 are examples, and for example, a table and a field may be added according to an application. In addition, the table configuration may be changed as long as similar information is held. For example, the image/text information table 300 may be divided into an image information table and a text information table, or information on an input/output relationship of image generation may be managed in a separate table.

The image/text information table 300 includes an ID field 301, a type field 302, an image field 303, a text field 304, an input text ID field 305, an input image ID field 306, an input mask ID field 307, and a feature amount field 308.

The ID field 301 holds an identification number of the image/text information. The type field 302 holds a type of information. The type of information is, for example, text, an image, a mask image, or the like. Here, the mask image is an image in which information of a region that gives a change to the input image in image generation is recorded. When the type is an image, the image field 303 holds binary data of the image. If binary data of an image can be accessed, a file path on a file storage may be used.

In a case where the type is a text, the text field 304 holds a character string of the text. The input text ID field 305 holds an ID managed in the image/text information table 300 for the input text used for image generation. The input image ID field 306 holds an ID managed in the image/text information table 300 for the input image used for image generation. The input mask ID field 307 holds an ID managed in the image/text information table 300 for the input mask image used for image generation. The feature amount field 308 holds a numerical vector representing a feature amount extracted from an image or a text.

A field may be added to the image/text information table as necessary. For example, time when data is registered, information of a model used for image generation, various parameters (for example, random number seed) used for image generation, rating of an image generated by a user, and the like may be added. Furthermore, in a case of using an image generation model that receives a plurality of input texts or input images, the input text ID field 305, the input image ID field 306, and the input mask ID field 307 may be able to hold a plurality of IDs. Also for the feature amount field 308, a plurality of fields may be prepared, the results calculated by a plurality of feature amount extraction methods may be held, and which feature amount is used may be selected at the time of retrieval.

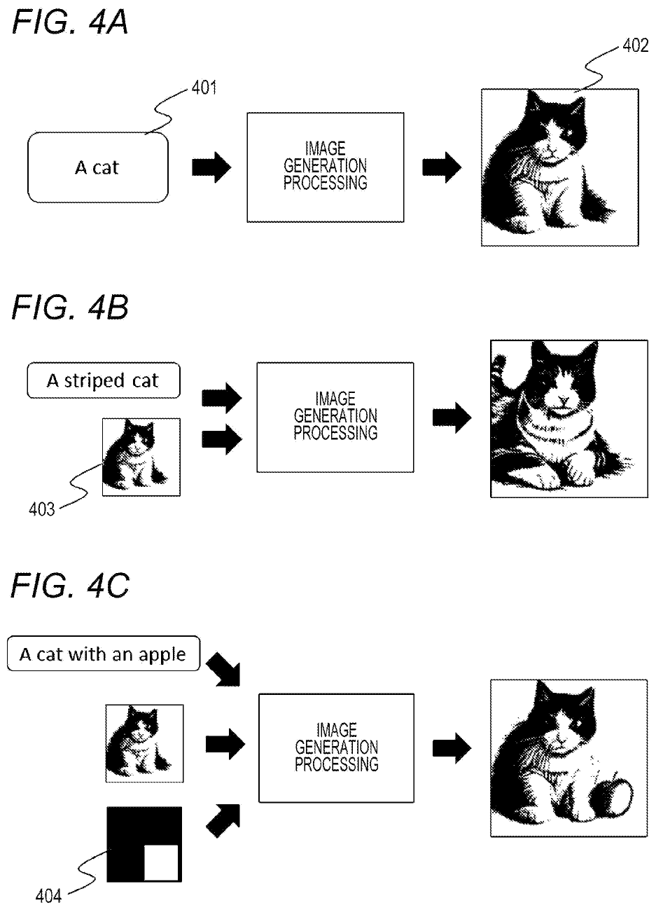

FIGS. 4A, 4B, and 4C are diagrams illustrating an outline of image generation processing of the image generation unit 107 of the present Example. The image generation processing is processing of automatically generating an image according to the content of the input text, and a known algorithm as described in High-Resolution Image Synthesis with Latent Diffusion Models can be used. The image generation processing of the image generation unit 107 of the Example roughly uses three types of input/output patterns.

In the image generation from the text, one or more images 402 according to the content of the text are generated from one input text 401 (see FIG. 4A).

In the image generation from the text/image, the input image 403 is corrected according to the content of the text (see FIG. 4B).

In the image generation from the text, the image, and the mask, correction is made to the region specified by the mask image 404 with respect to the input image (see FIG. 4C). In FIG. 4C, a black region of the mask image 404 holds information of the input image, and a white region generates an image according to the input text. The mask image may be given as a binary value of whether or not to add correction, or may be given as a continuous value representing the strength of correction.

Although the three types of patterns have been described above, the image generation processing of the image generation unit 107 of the present Example is not limited thereto, and if a field is added to the image/text information table 300, derived image generation algorithms having different input/output numbers may be used. For example, an image of the intermediate concept may be generated by inputting a plurality of texts. Furthermore, by resizing or trimming the input image and inputting the resized or trimmed input image to the image generation model, it may correspond to processing of drawing outside the frame of the input image (OutPainting).

FIG. 5 is a diagram illustrating a processing flow of image generation/database registration. The image generating and retrieving system 100 according to the present Example performs image generation with an input of text for image generation by the user as a trigger, and automatically performs database registration processing unless otherwise specified. Each step of FIG. 5 will be described below.

The text input unit 105 receives information similar to a text from the input device 102 and converts the information into text data that can be used inside the system as necessary (S501). The text registration unit 108 calculates a feature amount from the text data acquired in step S501 and registers the feature amount in the image/text database 110 (S502).

In a case of using the initial image for input of the image generation processing, the image generating and retrieving apparatus 104 executes step S504, and otherwise, executes step S506 (S503). The image input unit 106 acquires an initial image to be an input of the image generation processing from the image storage device 101, and converts the initial image into image data that can be used inside the system as necessary (S504).

The image registration unit 109 calculates an image feature amount from the initial image data and registers the image feature amount in the image/text database 110 (S505). The image generation assisting unit 113 receives image generation conditions from the input device 102 (S506). The image generation conditions are, for example, parameters such as the input pattern of the image generation processing described in the description of FIG. 4, the type of the generation model, the random number seed, and the number of images to be output. Furthermore, in a case of using a mask image for the generation processing, information of the mask region is received from the input device 102, and the mask image is generated.

The image generating and retrieving apparatus 104 executes step S508 in a case of using the mask image for the image generation processing, and executes step S510 otherwise (S507).

The image registration unit 109 calculates a feature amount from the mask image generated in step S506 and registers the feature amount in the image/text database 110 (S508). The image generation unit 107 generates an image from the text input in step S501 according to the condition input in step S506 (S509). According to the specified condition, the initial image input in step S504 and the mask image generated in step S506 are added to the input of the image generation processing.

The image registration unit 109 calculates a feature amount from the generated image obtained in step S509, and registers the feature amount in the image/text database 110 (S510). In addition, when the generated image is registered, information of the input data used for the generation processing is also recorded.

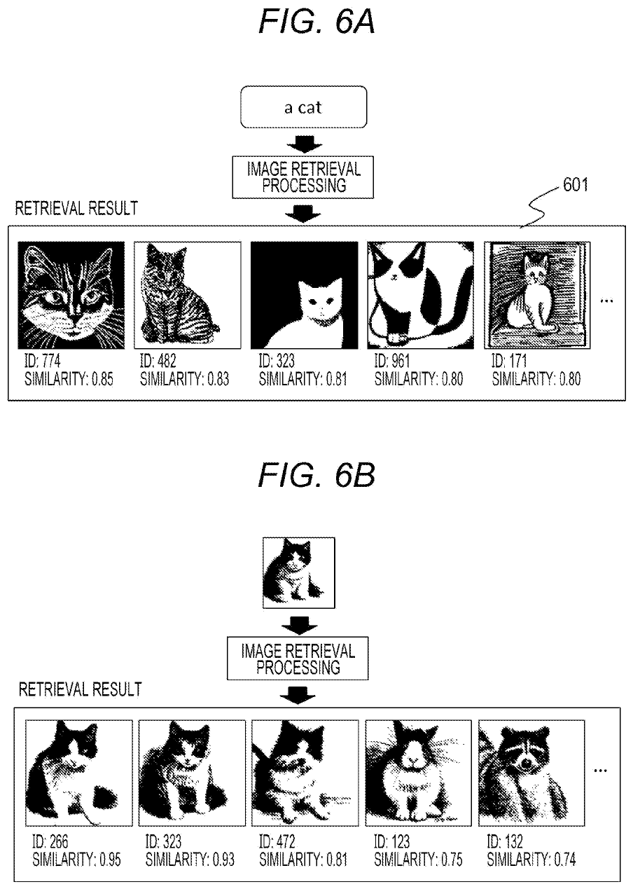

FIGS. 6A and 6B are diagrams illustrating an outline of similar image retrieval processing of the retrieval unit 111 according to the present Example. The image generating and retrieving apparatus 104 according to the present Example extracts mutually comparable feature amounts from an image and a text, and holds the extracted feature amounts in the image/text database 110. Therefore, by comparing the feature amounts, it is possible to acquire similar data from the image/text database 110 using the image or the text as a query.

In the retrieval processing, (a) image retrieval from the query text, (b) image retrieval from the query image, (c) text retrieval from the query text, and (d) text retrieval from the query image can be performed. FIG. 6A illustrates an example of (a) for acquiring a similar image. FIG. 6B illustrates an example of (b) for acquiring a similar image.

As illustrated in FIG. 6A, in the image retrieval from the query text, the feature amount is extracted from the input query text and used as the query feature amount. The similarity between the registered feature amount and the query feature amount is calculated for the type of the registered data of the image/text database 110 that is the image. The feature amount is multi-dimensional vector data, and the similarity between the two vectors can be calculated using, for example, cosine similarity.

A retrieval result 601 is given by the ID managed in the image/text information table 300 and the similarity obtained by vector calculation. In the case of image retrieval from the query text, whether or not the concept of the text is included is emphasized, and thus there is a strong tendency that the image characteristics of the retrieval results are different from each other.

As illustrated in FIG. 6B, also in the case of the image retrieval from the query image, the procedure is similar, the query feature amount is calculated from the input query image, and the image/text database 110 is retrieved. In a case of using the query image, since the feature amount includes various image characteristics that cannot be expressed by texts, there is a strong tendency that an image having a similar atmosphere or composition appears in the retrieval result. On the other hand, there is a tendency that an image not including an intended concept appears in the retrieval result.

FIG. 7 is a diagram illustrating a processing flow of the similar image retrieval of the retrieval unit 111 of the present Example. Each step of FIG. 7 will be described below.

The retrieval unit 111 executes step S702 when the retrieval query is a text, executes step S703 when the retrieval query is an image, and executes step S704 when the retrieval query is specified by the ID of the database (S701).

If there is a retrieval narrowing condition, the retrieval unit 111 executes step S706, and if not, executes step S707 (S705). The retrieval unit 111 extracts the feature amount from the query text (S702). The feature amount extraction processing is performed by the same method as the text registration unit 108.

The retrieval unit 111 extracts the feature amount from the query image (S703). The feature amount extraction processing is performed by the same method as the image registration unit 109. The retrieval unit 111 acquires the feature amount of the specified ID from the image/text database 110 (S704).

The retrieval unit 111 narrows down the similarity calculation target from the records registered in the image/text database 110 using the specified narrowing condition (S706). For example, in a case of a narrowing condition in which the type is only an image, the retrieval result calculated and output as similarity is only an image.

The retrieval unit 111 calculates the similarity with the feature amount acquired in step S702, step S703, or step S704 for all the target records of the similarity calculation (S707). For similarity calculation, cosine similarity between two vectors and the like can be used. In addition, a known approximate nearest neighbor retrieval method of retrieving only records having high similarity at a high speed without calculating similarity of all records by collectively storing data having high similarity in advance may be applied.

The retrieval unit 111 rearranges the retrieval results using the similarity, and outputs the results of the specified number (S708). In the similar image retrieval, the retrieval results are normally output in descending order of similarity, but may be output in ascending order of similarity or an upper limit or a lower limit may be set for the similarity depending on the purpose. Furthermore, various retrieval results may be output by thinning out the retrieval results so that the similarity between the retrieval results is equal to or less than a constant value.

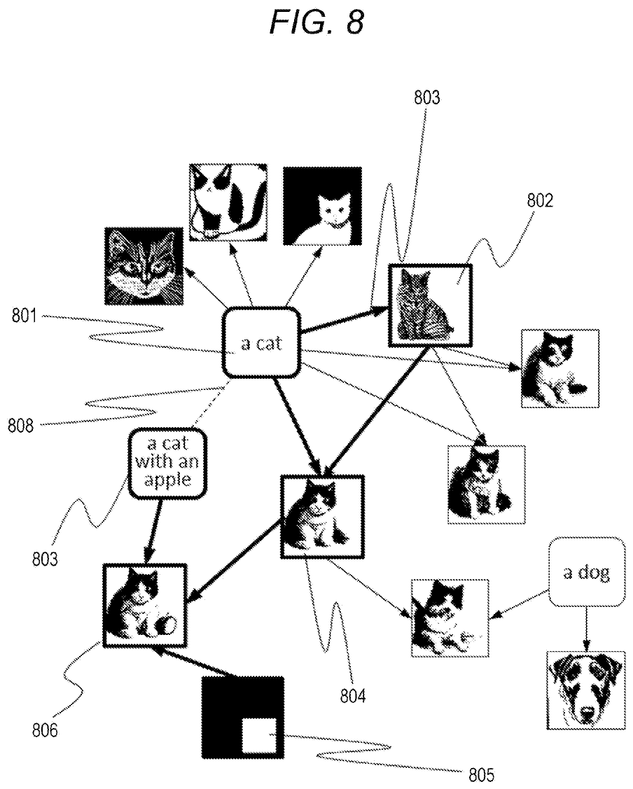

FIG. 8 is a diagram illustrating an outline of visualization of an image generation process of the display unit 112 of the present Example. Since the image/text database 110 of the present Example holds the information of the input/output relationship of the image generation processing, the user can know the effective procedure from the past image generation by visualizing the information.

In FIG. 8, the generation process is visualized by a directed graph including nodes and edges. Each node represents each record registered in the image/text database 110, and displays a thumbnail of an image or displays a text according to a type. The edge represents an input/output relationship, and a node connected to a start point of an arrow is input data and a node connected to an end point is a generated image that is output. For example, a process in which an image 802 is generated by a text 801 is expressed by an edge 803. An arbitrary image generation process can be visually grasped by the directed graph.

For example, it can be seen that the text 801 is used for a large number of image generation processing, and it can be seen that the image 806 is generated using the text 803 and the mask 805 with respect to the image 804 obtained through several number of image generation processes. In the visualization of the graph, the visibility may be deteriorated when the number of pieces of data is increased, but a generally conceivable simplified display method such as displaying only the periphery of the node of interest or collectively displaying generation processes under the same conditions may be applied.

Furthermore, since the record represented by each node has a feature amount with which similarity can be calculated, control may be performed such that nodes having close similarity are arranged at close positions. For example, since the text 801 and the text 803 have high similarity, the drawing of the graph may be controlled by giving a virtual edge 808.

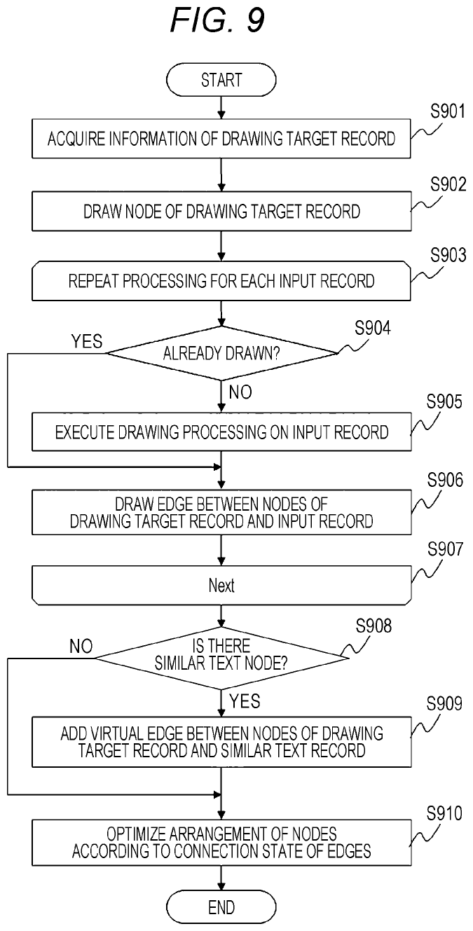

FIG. 9 is a diagram illustrating a processing flow of visualization of an image generation process of the display unit 112 of the present Example. Each step of FIG. 9 will be described below.

The retrieval unit 111 acquires information of the drawing target record specified by the user from the image/text database 110 (S901).

The display unit 112 adds a node to the graph by using the information of the drawing target record acquired in step S901 (S902).

The display unit 112 executes steps S904 to S906 for an input record in the generation processing held by the drawing target record acquired in step S901 (S903). Here, the input record is a record of an ID held in the input text ID field 305, the input image ID field 306, and the input mask ID field 307 of the image/text information table 300.

If the input record has already been drawn in the graph, the display unit 112 executes step S906, and if not, the display unit 112 executes step S905 (S904).

The image generating and retrieving apparatus 104 performs the processing flow of FIG. 9 with the input record as the drawing target record (step S905).

The display unit 112 adds an edge between nodes of the drawing target record and the input record (S906). The edge is a directed edge from the node of the input record to the node of the drawing target record.

When the processing is completed for all the input records, the display unit 112 executes step S908 (S907). In a case where the type of the drawing target record is a text and there is a node of a text record having a high similarity, the display unit 112 executes step S909, and otherwise, executes step S910 (S908).

The display unit 112 adds a virtual edge between nodes of the drawing target record and the text record having high similarity (S909). The virtual edge is added to control the drawing position of the node, and may or may not be displayed on the screen to be presented to the user.

The display unit 112 optimizes the arrangement of the nodes according to the connection state of the edges (S910). The optimization can use a known graph drawing method. For example, a method of obtaining an arrangement in which a basic repulsive force between nodes and an attractive force between nodes connected by an edge are balanced by repetitive calculation can be used.

### Example 2

The image generating and retrieving apparatus 104 of Example 1 makes it possible to retrieve the generated image accumulated in the image/text database using texts and images, and to efficiently find an image desired by the user by visualizing the image generation process. However, when a new image is generated, it is necessary for the user to explicitly perform image retrieval or to confirm a visualized graph in the generation process.

The image generating and retrieving apparatus 104 according to Example 2 automatically analyzes a large number of images generated under predetermined conditions, thereby preferentially presenting images expected by the user. As a result, an image can be efficiently obtained even in a case of generating an image under a new condition.

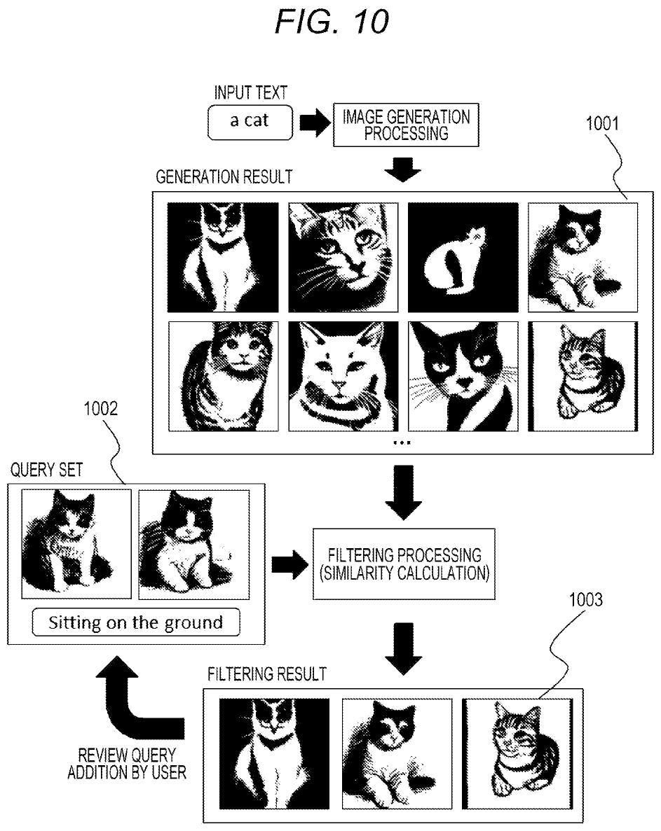

FIG. 10 is a diagram for describing filtering processing of an image generation result based on the similarity in Example 2. The image generation unit 107 can generate a large number of images in response to one image generation request from the user by changing the image generation model and the image generation parameter.

The image generating and retrieving apparatus 104 according to Example 2 performs similarity calculation on a generation result 1001 by using a query set 1002 set in advance and calculates a score, thereby outputting an image whose score is a predetermined threshold or more as a filtering result 1003.

The query set 1002 can be provided as an image or a text, and can be interactively added by the user. The score of an evaluation target image is calculated, for example, by calculating the degree of similarity between each query and the evaluation target image, and adding the degree of similarity with a weight as necessary. By setting a negative value to the weight of the query, the score of the image having low similarity with the query can be increased. For example, by collecting generated images having low similarity with the query, it is possible to obtain images with a wide variety.

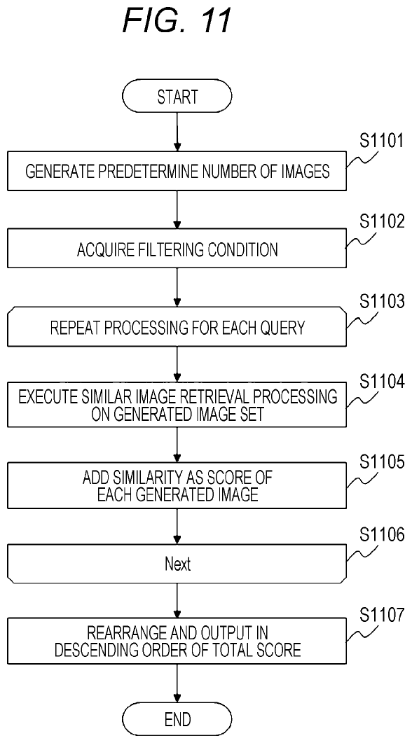

FIG. 11 is a diagram illustrating a processing flow of filtering the image generation result according to the similarity of Example 2. Each step of FIG. 11 will be described below.

The image generation unit 107 generates a predetermined number of images using a predetermined combination of image generation models and image generation parameters (S1101).

The retrieval unit 111 acquires a filtering condition from the input device 102 (S1102). The filtering condition is a query with one or more images or texts, a weight of each query, a score threshold, or the like.

The retrieval unit 111 executes steps S1104 to S1105 for each query specified by the filtering condition acquired in step S1102 (S1103). The retrieval unit 111 performs similar image retrieval processing using the query image or the query text on the generated image set generated in step S1101, and acquires a retrieval result (S1104).

The retrieval unit 111 adds the similarity with the query acquired in step S1104 to the score of each generated image (S1105). In a case where a weight is given to the query in the filtering condition acquired in step S1102, the query is weighted and then added.

When the processing is completed for all the queries, the retrieval unit 111 executes step S1107 (S1106). The retrieval unit 111 rearranges the generated images in descending order of the total score and outputs a predetermined number (S1107). When a score threshold is set in the filtering condition acquired in step S1102, generated images each having a score equal to or larger than the threshold are output.

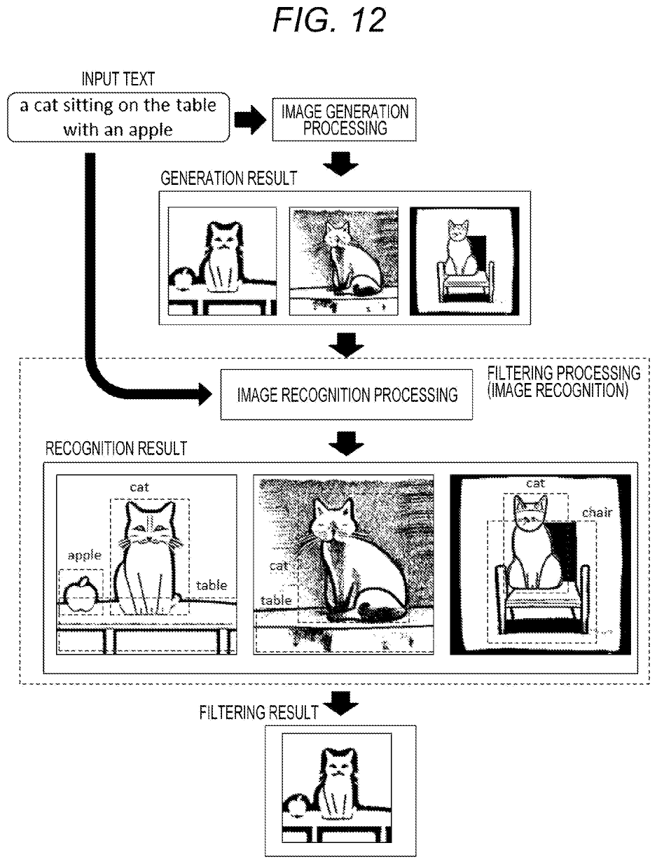

FIG. 12 is a diagram for describing filtering processing of an image generation result by image recognition of Example 2. The image generation unit 107 can automatically generate an image according to the content of the input text, but an image that does not necessarily include all the concepts included in the input text may be generated depending on the image generation model and the image generation parameter.

The image generating and retrieving apparatus 104 according to Example 2 automatically verifies whether or not each concept included in the input text is also included in the generated image by image recognition processing. In the example of FIG. 12, an object is detected by the image recognition processing with respect to the generated image, and the filtering processing is performed by calculating a score based on whether or not objects of “cat”, “apple”, and “table” included in the input text are included.

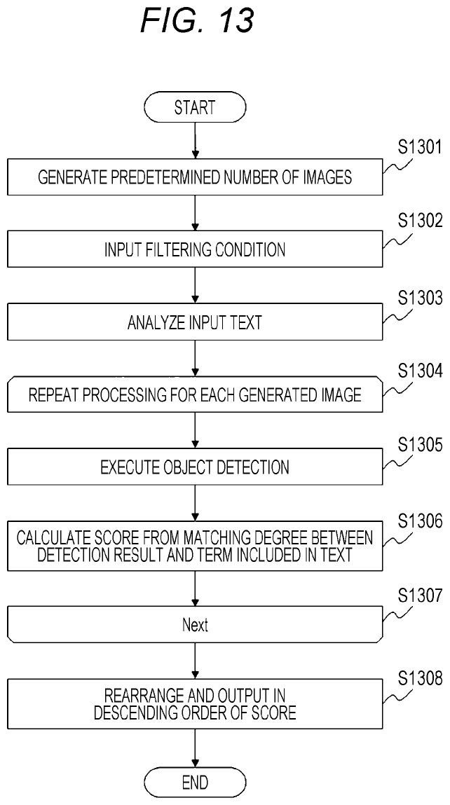

FIG. 13 is a diagram illustrating a processing flow of filtering an image generation result by image recognition of Example 2. Each step of FIG. 13 will be described below.

The image generation unit 107 generates a predetermined number of images using the input text and a predetermined combination of image generation models and image generation parameters (S1301).

The retrieval unit 111 acquires the filtering condition from the input device 102 (S1302). The filtering condition is an object detection algorithm used for image recognition or a parameter thereof. As the object detection algorithm, a known algorithm described in GLIPv2: Unifying Localization and VL Understanding can be used.

The retrieval unit 111 extracts a term list of an object that can be detected by the object detection algorithm specified in step S1302 from the input text used for image generation in step S1301 (S1303).

The retrieval unit 111 executes steps S1305 to S1306 for each query specified by the filtering condition acquired in step S1302 (S1304).

The retrieval unit 111 executes the object detection processing on each generated image generated in step S1301 (S1305). The retrieval unit 111 calculates a score from the matching degree between the list of objects detected in step S1304 and the term list acquired in step S1303, and adds the score to the total score of each generated image (S1306).

When the processing is completed for all the queries, the retrieval unit 111 executes step S1308 (S1307). The retrieval unit 111 rearranges the generated images in descending order of the total score and outputs a predetermined number (S1308). When a score threshold is set in the filtering condition acquired in step S1302, generated images each having a score equal to or larger than the threshold are output.

FIGS. 11 and 12 illustrate an example in which the matching degree between the contents of the input text and the generated image is determined using the object detection algorithm. However, the image generating and retrieving apparatus 104 according to Example 2 can use any image recognition algorithm as long as the matching degree between the contents of the input text and the generated image can be obtained.

For example, the matching degree may be determined based on the similarity between the text generated using the image explanatory text generation algorithm and the input text. In addition, even in a case of using the object detection algorithm, the matching degree may be calculated in consideration of the positional relationship of the objects. For example, from the relationship between “cat” and “on the table”, the score of a generated image in which “cat” is located on “table” in the result of object detection may be increased.

### Example 3

The image generating and retrieving apparatus 104 according to Example 2 can efficiently present an image desired by the user by image analysis processing from a large number of images generated under predetermined conditions. On the other hand, the user needs to adjust the image generation conditions by trial and error.

The image generating and retrieving apparatus 104 according to Example 3 can present candidates of a text and a mask image to be input to image generation to the user by retrieving past generated images accumulated in the image/text database 110.

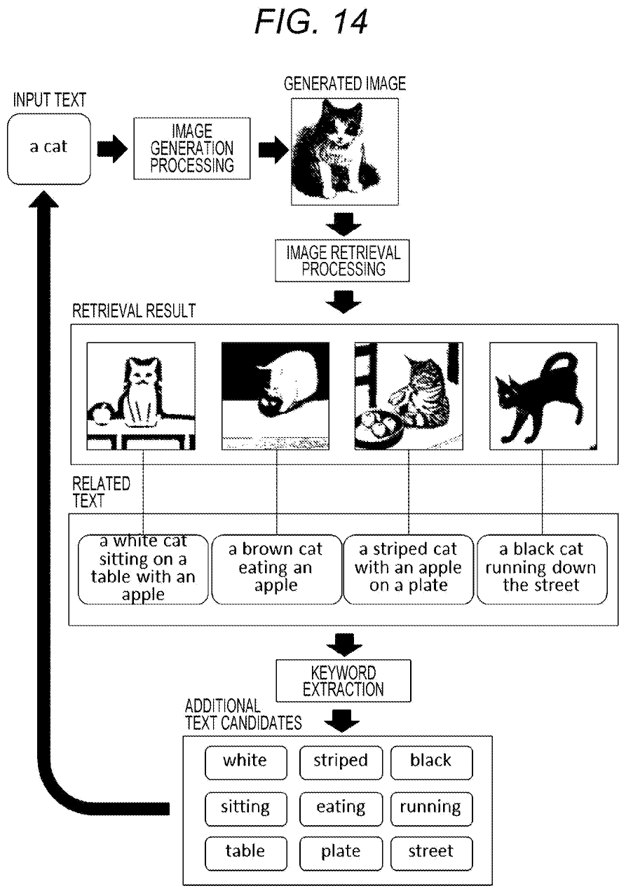

FIG. 14 is a diagram for explaining text input assistance by image retrieval of Example 3. A similar image generated in the past is retrieved from the image/text database 110 using the generated image obtained using the input text as a query. Since the image/text database 110 holds the information in the input/output process of the image generation processing, the input text used for the image generation processing can be acquired from each image of the retrieval result.

The image generation assisting unit 113 of Example 3 can extract a keyword used for image generation by analyzing a text obtained from a similar image. The keyword extraction may simply enumerate the appearing terms, or may calculate a score of the term using an arbitrary statistical index and change the display order according to the score. For example, a term frequency (TF) may be used as an index, or a statistic TF-IDF that is a product of the TF and an inverse document frequency (IDF) may be used as an index. Here, TF is the frequency of a term included in the similar image retrieval result, and IDF is the reciprocal of the number of texts including the term from all records of the image/text database 110. When the TF-IDF is used, it is possible to extract terms that appear more than usual in the similar image retrieval result.

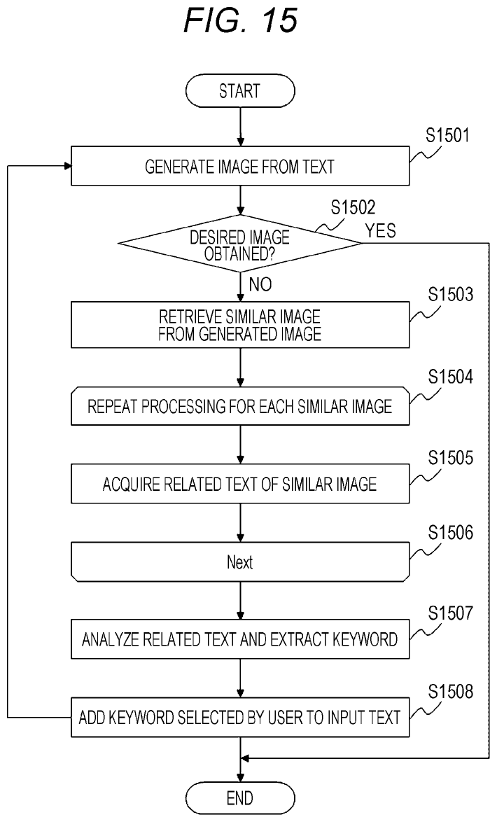

FIG. 15 is a diagram illustrating a processing flow of text input assistance by image retrieval of Example 3. Each step of FIG. 15 will be described below.

The image generation unit 107 generates an image from the input text (S1501). Step S1501 is equivalent to the image generation processing described with reference to FIG. 5.

In a case where it is determined that the user has obtained a desired image, the image generation assisting unit 113 ends the processing, and otherwise, executes step S1503 (S1502).

The image retrieval unit 111 retrieves a similar image from the image/text database 110 using the generated image acquired in step S1501 as a query (S1503). Step S1503 is equivalent to the image search processing described with reference to FIG. 7.

The image generation assisting unit 113 executes step S1505 on each similar image acquired in step S1503 (S1504).

The image retrieval unit 111 acquires the related text of the similar image from the image/text database 110 (S1505). The related text is, for example, data held in the text field 304 of the record corresponding to the ID held in the input text ID field 305 of the record of the similar image.

When the processing is completed for all the similar images, the image generation assisting unit 113 executes step S1507 (S1506). The image generation assisting unit 113 extracts a keyword set from the related texts acquired in step S1505 (S1507). As described in the description of FIG. 14, the keyword extraction method may be simple enumeration of terms or a result of scoring using TF or TF-IDF that is a statistical index.

The image generation assisting unit 113 adds the keyword selected by the user with the input device 102 from the keyword set extracted in step S1507 to the input text (S1508). At this time, a keyword may be simply added to the end of the text, or a text obtained using a known text generation algorithm for generating a text from the keyword may be added.

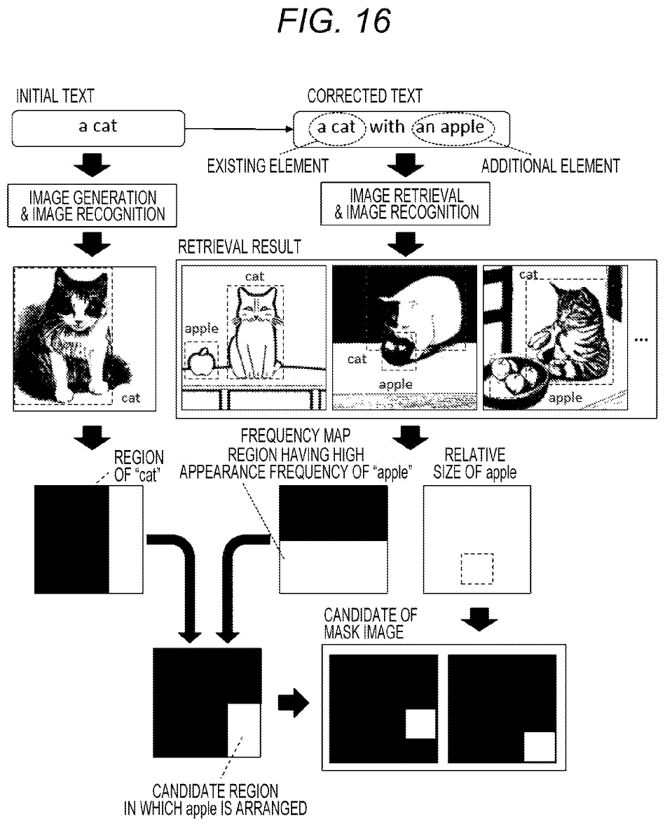

FIG. 16 is a diagram for explaining mask input assistance by image retrieval of Example 3. As described in FIG. 4C, the image generating and retrieving apparatus 104 of the present invention can generate an image in which a part of the input image is corrected by inputting the mask image.

When generating an image with a corrected text by newly adding an additional element while leaving the existing element included in the initial text as it is, the image generation assisting unit 113 of Example 3 retrieves a similar image from the image/text database 110 using the corrected text and calculates a frequency map indicating in which region in the image the additional element is likely to appear. A candidate region in which the additional element is arranged is obtained from the frequency map and the region of the existing element in the image generated with the initial text. In addition, a relative size of the additional element with respect to the existing element is calculated, one or more regions in which the relative size can be arranged are selected in the candidate region, and the candidate of the mask image is generated.

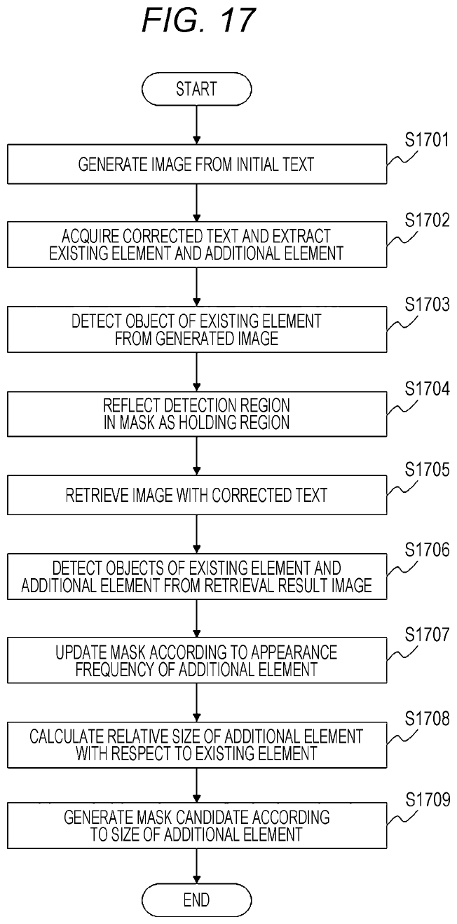

FIG. 17 is a diagram illustrating a processing flow of mask input assistance by image retrieval of Example 3. Each step of FIG. 17 will be described below.

The image generation unit 107 generates an image from the initial text (S1701). Step S1701 is equivalent to the image generation processing described with reference to FIG. 5. The image generation assisting unit 113 analyzes the corrected text input by the user, and extracts the existing element included in the initial text and a newly added additional element (S1702).

The image generation assisting unit 113 detects an object of the holding element extracted in step S1702 from the generated image acquired in step S1701 (S1703). The image generation assisting unit 113 reflects an object region detected in step S1703 in the mask image as a holding region (S1704). Here, the holding region is a region that is not corrected by the image generation processing, and is expressed as a black region in the mask image of FIG. 16.

The retrieval unit 111 retrieves a similar image from the image/text database 110 using the corrected text acquired in step S1702 as a query (S1705). The image generation assisting unit 113 detects the objects of the existing element and the additional element extracted in step S1702 from each similar image obtained in step S1705 (S1706).

The image generation assisting unit 113 creates an appearance frequency map by aggregating appearance regions of the additional elements detected in step S1706, and updates the mask image so as to set a place having a high appearance frequency as a correction region (S1707). Here, the correction region is a region to be corrected by the image generation processing, and is expressed as a white region in the mask image of FIG. 16.

The image generation assisting unit 113 calculates the relative size of the additional element with respect to the existing element from the object regions of the existing element and the additional element detected in step S1706 (S1708).

The image generation assisting unit 113 selects one or more regions in which the relative size of the additional element calculated in step S1708 is accommodated from the correction region of the mask image obtained in step S1707, and generates a mask image in which the region is set as the correction region (S1709).

With the image generating and retrieving apparatus 104 of Examples 1 to 3 described above, it is possible to generate a large number of images according to the content of the input text and efficiently find an image desired by the user from the generated image. Furthermore, in a new image generation procedure, it is possible to perform efficient generation by filtering and displaying the generated image by the image analysis processing, or presenting candidates of the text and the mask image used for image generation.

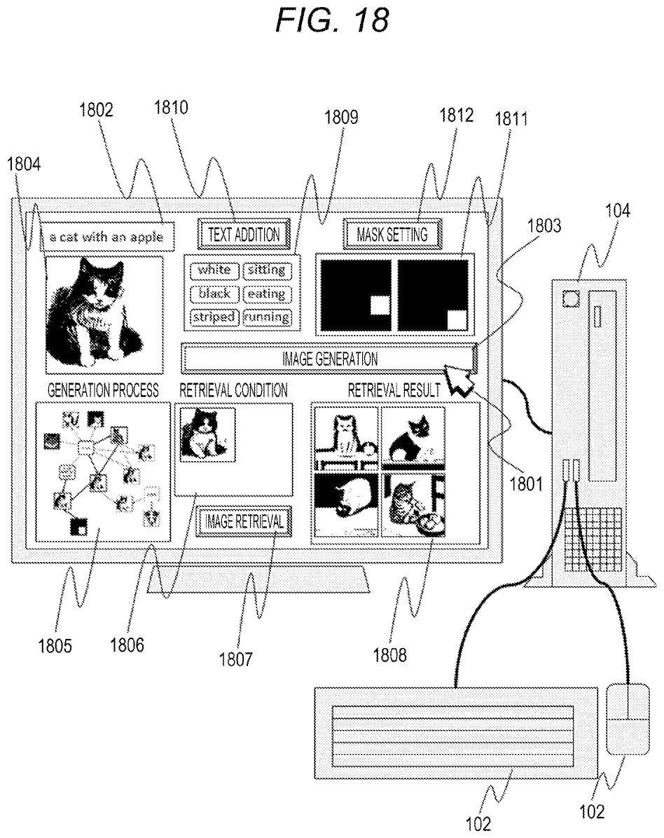

FIG. 18 is a diagram illustrating a configuration example of an operation screen for performing image generation and image retrieval in the image generating and retrieving apparatus 104 of Examples 1 to 3.

The image generating and retrieving apparatus 104 displays a processing result on the display device 103. The user notifies the image generating and retrieving apparatus 104 of the operation information by using a mouse cursor 1801 or the like displayed on the screen by the input device 102. The screen includes a text input field 1802, an image generation button 1803, a generated image display field 1804, a generation process visualization field 1805, a retrieval condition field 1806, an image retrieval button 1807, an image retrieval result field 1808, a text candidate field 1809, a text addition button 1810, a mask candidate field 1811, and a mask setting button 1812. The configuration example of the screen is an example, and the screen may be configured by freely arranging these elements.

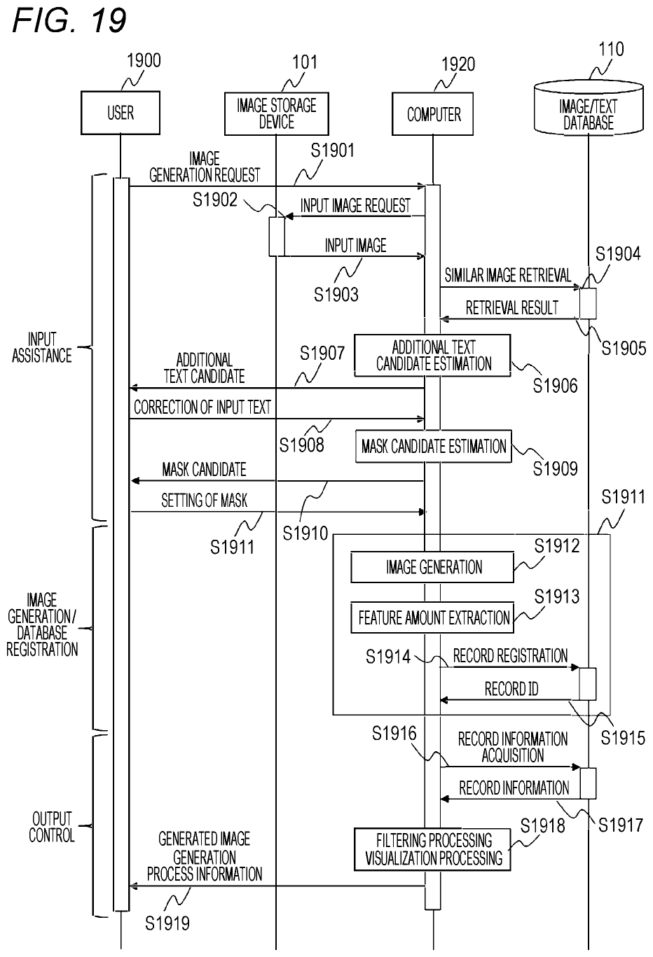

FIG. 19 is a sequence diagram illustrating a process of performing image generation and image retrieval in the image generating and retrieving apparatus 104 of Examples 1 to 3.

Specifically, FIG. 19 illustrates a processing sequence among the user 1900, the image storage device 101, the computer 1920, and the image/text database 110 in each processing of the image generating and retrieving system 100 described above. The sequence of FIG. 19 roughly includes the input auxiliary processing described in Example 3, the image generation/database registration processing described in Example 1, the output control processing, and the output control processing described in Example 2, and these sequences are repeatedly executed in response to a user's request. Note that the computer 1920 is a computer that implements the image generating and retrieving apparatus 104. Each step of FIG. 19 will be described below.

When the user 1900 issues an image generation request (S1901), a series of processing related to image generation is started in the computer 1920. When an input image is used for image generation, the computer 1920 requests the input image from the image storage device 101 (S1902), and the image storage device 101 returns the input image (S1903).

The computer 1920 sends a similar image retrieval request with the input image as a query to the image/text database 110 (S1904), and the image/text database 110 returns a retrieval result (S1905). The computer 1920 estimates an additional text candidate from the text acquired from the retrieval result (S1906), and presents the additional text candidate to the user 1900 (S1907). The user corrects the input text using the presented candidate and inputs the corrected input text to the computer 1920 (S1908). The computer 1920 estimates a mask candidate from the corrected text and the image retrieval result (S1909), and presents the mask candidate to the user 1900 (S1910). The user 1900 inputs the mask image to the computer 1920 with reference to the presented mask image (S1911).

The computer 1920 generates an image using the input text, image, and mask image (S1912). The computer 1920 extracts a feature amount from the text, the image, the mask image, and the generated image used for generation (S1913), and registers the feature amount in the image/text database 110 (S1914). The image/text database 110 returns the ID of the registered record (S1915). The computer 1920 acquires information of a record from the image/text database 110 using the ID (S1917), performs filtering processing and visualization processing (S1918), and presents the result to the user (S1919).

According to the above embodiment, it is possible to present information in which an image is easily found. Furthermore, it is possible to present appropriate auxiliary information to the user when the image generation is performed again. It is considered that the effect of the above Example becomes remarkable by the appearance of a method capable of generating a large number of images of various concepts and variations by natural language.

More specifically, according to the above Example, it is possible to narrow down and present an image that meets the user's intention from a large number of images generated by text input. In addition, it is possible to assist input of image generation by retrieving the generated image accumulated in the image/text database, extracting conditions such as text candidates to be input to new image generation, and presenting the conditions to the user. Furthermore, it is possible to visualize the input/output relationship of image generation accumulated in the database and present the visualized input/output relationship to the user.

The Examples according to the present invention have been described above. It should be noted that the present invention is not limited to the above-described Examples, but includes various modified examples. For example, the above-described Examples have been described in detail in order to explain the present invention in an easy-to-understand manner, and are not necessarily limited to those having all the described configurations. In addition, a part of the configuration of a certain Example can be replaced with the configuration of another Example, and the configuration of another Example can be added to the configuration of a certain Example. In addition, it is possible to add, delete, and replace other configurations for a part of the configuration of each Example.

Further, each of the configurations, functions, processing units, processing means, etc. described above may be implemented by hardware, for example, by designing part or all of them with an integrated circuit. In addition, each of the above-described configurations, functions, and the like may be implemented by software by a processor interpreting and executing a program for implementing each function. Information such as a program, a table, and a file for implementing each function can be stored in a recording device such as a memory, a hard disk, and a solid state drive (SSD), or a recording medium such as an IC card, an SD card, and a DVD.

Further, control lines and information lines indicate what is considered to be necessary for the description, and not all control lines and information lines in the product are necessarily shown. In practice, almost all configurations may be considered to be mutually connected.

What is claimed is:

1. An image generating and retrieving apparatus having a processor, the image generating and retrieving apparatus comprising:
an image generation unit that acquires, by the processor, a new generated image by image generation processing from an input text and an input image that have been input;
a text registration unit that calculates a text feature amount from the input text by the processor;
an image registration unit that calculates an image feature amount from the input image and the generated image by the processor;
an image text database that holds the input text, the input image, the generated image, the image feature amount, the text feature amount, and an input/output relationship in the image generation processing as an image generation process;
a retrieval unit that calculates a similarity from the text feature amount and the image feature amount by the processor, and retrieves a similar image similar to a retrieval target from the image text database by using the similarity; and
a display unit that visualizes the image generation process held in the image text database by the processor.

2. The image generating and retrieving apparatus according to claim 1, further comprising:
a text input unit that receives the input text by the processor;
an image input unit that receives the input image by the processor; and
an image generation assisting unit that assists the image generation processing of the generated image by the processor.

3. The image generating and retrieving apparatus according to claim 1, wherein
the retrieval unit
retrieves, by the processor, the image text database using a retrieval query given by the input text or the input image, and
rearranges, by the processor, the retrieved similar images according to the similarity.

4. The image generating and retrieving apparatus according to claim 1, wherein the display unit visualizes, by the processor, the image generation process as a graph indicating the input/output relationship by arranging the generated image and the similar image.

5. The image generating and retrieving apparatus according to claim 1, wherein
the image generation unit acquires, by the processor, a predetermined number of the generated images as a generated image set, and
the retrieval unit retrieves, by the processor, the similar image by a query image or a query text for the generated image set by filtering processing using the similarity, and outputs, by the processor, a retrieval result as a filtering result.

6. The image generating and retrieving apparatus according to claim 5, wherein
the retrieval unit
calculates, by the processor, a score by calculating the similarity using a query set preset for the generated image in the filtering processing, and
outputs, by the processor, the filtering result on a basis of the score.

7. The image generating and retrieving apparatus according to claim 1, wherein
the image generation unit acquires, by the processor, a predetermined number of the generated images from the input text, and
the retrieval unit recognizes, by the processor, whether a concept of a term included in the input text is included in the generated image by filtering processing using image recognition, and outputs a recognition result as a filtering result.

8. The image generating and retrieving apparatus according to claim 7, wherein
the retrieval unit
executes, by the processor, object detection processing on the generated image,
calculates, by the processor, a score from a matching degree between an object detection result in the object detection processing and the term included in the input text, and
outputs, by the processor, the filtering result on a basis of the score.

9. The image generating and retrieving apparatus according to claim 2, wherein
the image generation unit acquires, by the processor, the generated image from the input text by the image generation processing,
the retrieval unit retrieves, by the processor, the similar image from the image text database using the generated image as a query to acquire a related text of the similar image, and
the image generation assisting unit
extracts, by the processor, a plurality of keywords from the related text, and
adds, by the processor, the keyword selected by the user from the plurality of keywords to the input text to acquire the generated image again by the image generation processing.

10. The image generating and retrieving apparatus according to claim 2, wherein
the image generation unit acquires, by the processor, the generated image from an initial text,
the image generation assisting unit
acquires, by the processor, a corrected text input by a user and extracts an existing element included in the initial text and a newly added additional element, and
reflects a detection region obtained by detecting an object of the existing element from the generated image in a mask image as a holding region,
the retrieval unit retrieves, by the processor, the similar image from the image text database using the corrected text as a query, and
the image generation assisting unit
detects, by the processor, objects of the existing element and the additional element from the similar image, respectively,
updates the mask image according to an appearance frequency of the additional element,
calculates a relative size of the additional element with respect to the existing element, and
generates the mask image according to the relative size.

11. The image generating and retrieving apparatus according to claim 10, wherein the image text database holds the generated mask image.

12. An image generating and retrieving system, comprising:
the image generating and retrieving apparatus according to claim 1;
an input device that specifies a retrieval condition; and
a display device that displays a retrieval result.

13. The image generating and retrieving system according to claim 12, wherein
the display device includes an operation screen for performing the image generation processing and the retrieval, and
the operation screen includes a generation process visualization field for displaying the image generation process visualized by the display unit.

14. The image generating and retrieving system according to claim 13, wherein
the operation screen further includes:
a text input field for inputting the input text via the input device;
an image generation button for acquiring the generated image via the input device;
a generated image display field for displaying the generated image;
a retrieval condition field for specifying the retrieval condition via the input device;
an image retrieval button for performing the retrieval via the input device; and
an image retrieval result field for displaying the retrieval result.

15. An image generating and retrieving method, comprising:
an image generation step of acquiring, by the processor, a newly generated image from an input text and an input image that have been input by image generation processing;
a text registration step of calculating a text feature amount from the input text by the processor;
an image registration step of calculating, by the processor, an image feature amount from the input image and the generated image;
a holding step of holding the input text, the input image, the generated image, the image feature amount, the text feature amount, and an input/output relationship in the image generation processing in an image text database as an image generation process;
a retrieval step of calculating, by the processor, a similarity from the text feature amount and the image feature amount and retrieving a similar image similar to a retrieval target from the image text database by using the similarity; and
a display step of visualizing, by the processor, the image generation process held in the image text database.
